(19) United States
(12) Patent Application Publication
(10) Pub. No.: US 2003/0030675 A1
(43) Pub. Date: Feb. 13, 2003

(54) Entry panel processing system

(75) Inventors: William Hsiao-Yu Ku, Austin, TX (US); John Shih-Yuan Wang, Austin, TX (US); Derek Wan Hok Ho, Austin, TX (US); Joey Allen Perry, Pflugerville, TX (US)

Correspondence Address: Robert V. Wilder, Attorney at Law, 4235 Kingsburg Drive, Round Rock, TX, 78681, US

(73) Assignee: INTERNATIONAL BUSINESS MACHINES CORPORATION, Armonk, NY

(21) Appl. No.: 09/925,258

(22) Filed: Aug. 9, 2001

(51) Int. Cl. G09G 5/00

(52) U.S. Cl. 345/788

(57) ABSTRACT

A method and implementing computer system are provided in which user alert signals are generated whenever an underlying display window in a multi-window display environment requires user attention. In one exemplary embodiment, the user is enabled to specify various preferred characteristics of the alert signals. The alert signals include audio signals, video signals and combinations of selected audio and visual signals. The user is further enabled to specify input an alert repeat interval to define an elapsed time between successive alert signals.

### FIELD OF THE INVENTION

The present invention relates generally to information processing systems and more particularly to a methodology and implementation for processing information input panels.

### BACKGROUND OF THE INVENTION

Modern computer systems are designed to enable concurrent access to many applications at the same time. In networked systems, each of a number of different applications is displayed and executed within a different window on a display screen. If a user is running a browser program over the Internet, many websites may be accessed and run through different windows at the same time. Generally, the particular application or website window which is being worked by a user at any given time is overlaid on top of other windows containing other applications and websites. The user is able to switch among the windows to arrange selected window as the “top” window on the user's display screen within which the user is currently working.

For security and other reasons, many of the sites and applications which are accessible to a user require the input and processing of user logon information before access to the application or website is granted to a requesting user. Typically, a login panel or display window is presented to the user requesting input of the user identification and possibly a user password. In most cases, there is a time delay between the time access to a site is requested by a user and the time that the logon display panel for that site is presented. If the user does not respond to the login panel relatively quickly, the login panel may be covered by another panel or window from another running program which is or has been performing a task in the background. In that case the user may not be aware that the logon panel is present but not visible since it is “underneath” the top window on the user's display screen. Thus the user may not know that the user is being prompted to enter the requested security or other information. Subsequent attempts to use the requested window may then fail since the user never logged in and the appropriate security or other credentials were not given in response to the prompting login panel. In that case, the user will need to attempt another access to the requested site and incur the consequences of further processing delays.

Thus, there is a need for an improved methodology and implementing system which provides a means by which a user is made aware of the presence of a covered prompting display panel which requires user attention.

### SUMMARY OF THE INVENTION

A method and implementing computer system are provided in which user alert signals are generated whenever an underlying display window in a multi-window display environment requires user attention. In one exemplary embodiment, the user is enabled to specify various preferred characteristics of the alert signals. The alert signals include audio signals, video signals and combinations of selected audio and visual signals. The user is further enabled to specify input an alert repeat interval to define an elapsed time between successive alert signals.

### BRIEF DESCRIPTION OF THE DRAWINGS

A better understanding of the present invention can be obtained when the following detailed description of a preferred embodiment is considered in conjunction with the following drawings, in which:

FIG. 1 is a diagram of a computer system in which the present invention may be implemented;

FIG. 2 is a simplified schematic diagram showing selected components and subsystems of the computer system illustrated in FIG. 1;

FIG. 3 is an illustration of an exemplary display screen sequence helpful in explaining one aspect of the present invention;

FIG. 4 is a flow chart illustrating an exemplary implementation of the disclosed processing system; and

FIG. 5 is a flow chart illustrating an exemplary operational sequence in a multiple window process.

### DETAILED DESCRIPTION

The various methods discussed herein may be implemented within a typical computer system which may include a workstation or personal computer. In general, an implementing computer system may include a plurality of processors in a multi-bus system in a network of similar systems. However, since the workstation or computer system implementing the present invention in an exemplary embodiment, is generally known in the art and composed of electronic components and circuits which are also generally known to those skilled in the art, circuit details beyond those shown in the drawings are not specified to any greater extent than that considered necessary as illustrated, for the understanding and appreciation of the underlying concepts of the present invention and in order not to obfuscate or distract from the teachings of the present invention.

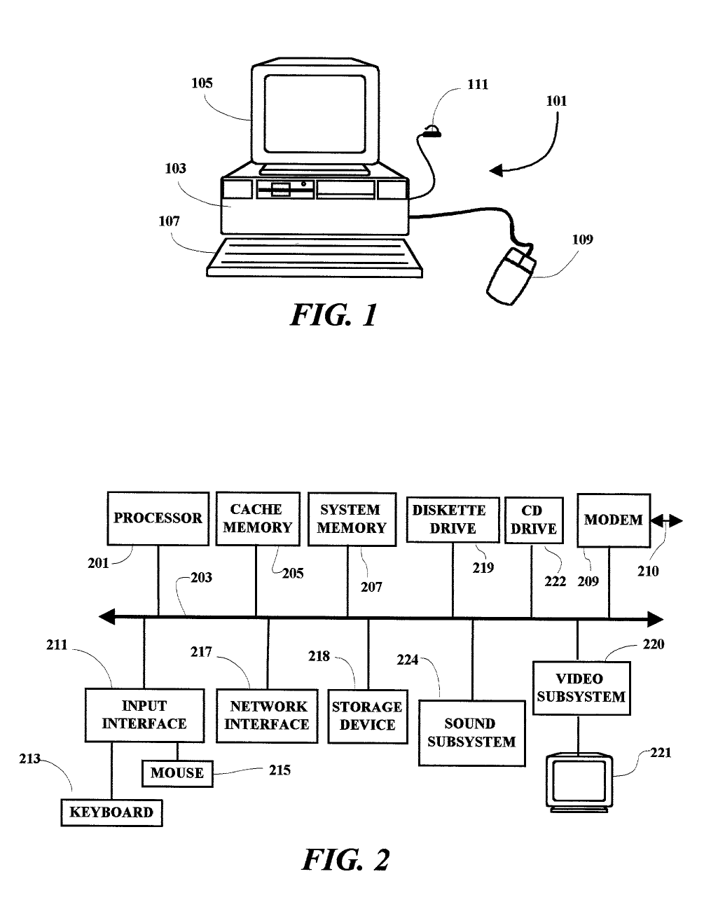

In FIG. 1, a computer system 101 includes an electronics enclosure 103 which is typically arranged for housing one or more CPUs (central processing units) along with other component devices and subsystems of the computer system 101. The computer system 101 also includes a monitor or display unit 105, a keyboard 107 and a mouse or pointing device 109, which are all interconnected within the illustrated computer system. Also shown is a connector 111 which is arranged for connecting a modem within the computer system to a communication line such as a telephone line in the present example. The present invention may also be implemented in a cellular system or other hard-wired or cable system without the connector 111.

Several of the major components of the system 101 are illustrated in FIG. 2. A processor circuit 201 is connected to a system bus 203 which may be any host system bus. It is noted that the processing methodology disclosed herein will apply to many different bus and/or network configurations. A cache memory device 205, and a system memory unit 207 are also connected to the bus 203. A modem 209 is arranged for connection 210 to a communication line, such as a telephone line, through a connector 111 (FIG. 1). The modem 209, in the present example, selectively enables the computer system 101 to establish a communication link and initiate communication with another computer system, or network or database server.

The system bus 203 is also connected through an input interface circuit 211 to a keyboard 213 and a mouse or other pointing device 215. The bus 203 is also coupled to a separate network subsystem interface 217, which may be connected directly in a network, and a diskette drive unit 219. A video subsystem 220, which may include a graphics subsystem, is connected to a display device 221. A storage device 218, which may comprise a hard drive unit or CD ROM, is also coupled to the bus 203. The diskette drive unit 219 provides a means by which individual diskette programs may be loaded on to the hard drive, or accessed directly, for selective execution by the computer system 101. As is well known, program diskettes or CDs containing application programs represented by magnetic or optical indicia on the diskette or CD, respectively, or programs in system memory, or acquired through a local network or through the world wide web may be read to provide program signals. Such program signals are selectively effective to cause the computer system to present displays on the screen of a display device and respond to user inputs in accordance with the functional flow of the application program being executed.

As herein disclosed, the present invention is explained in an Internet context although the invention is equally applicable to other multiple-window and network environments through which access may be had to a number of different applications, running through seperate windows. The disclosed methodology in an exemplary embodiment has been implemented within a browser program which is operating on the Internet to access a number of different selected websites through separate windows.

As the program is running, either a portion of the program or the entire program may be loaded into the system memory 207 and/or the system cache memory 205. Assuming a user has started-up the system, and is actively running a browser program for example, from memory, a series of screens will be displayed to the user on the display device 221. Each screen typically has one or more selections for the user to make in navigating through the World Wide Web for example. In general, a user will make selections from a display screen using the keyboard 213 or the mouse or pointer device 215. In an Internet operating program, the selections made by the user will determine “where” the user “goes”, i.e. to what “site” or “webpage”, and also, in some cases, the communications link or the path taken to get to the site selected.

As hereinbefore discussed, in a multiple window environment, an application or site logon screen may be presented on a user display and immediately covered by another window from another program such that a user may not become aware that the logon panel was presented. As a consequence, the user never logs on or inputs the requested logon information and never accesses the requested website. This problem can be solved by allowing the logon panel to always be on top of all other windows or by periodically bringing the logon panel to the foreground based upon a time interval that is set by the user. If the user decides to set the logon panel to always be on top of other windows, the logon panel will remain as the top window until the user inputs the requested logon information. The logon panel is a system-wide model panel which will prevent all other windows from overlaying the logon window. This forces the user to enter the requested logon information before proceeding with any other task.

Since, at times, the system-wide panel approach is not acceptable to the user because the user may need to handle other tasks before providing input to the login panel, a second mode is herein provided by which a user is enable to define a time period such that the login panel is brought to the foreground of the display at regular intervals. If any window covers the login panel, the login panel will be brought to the foreground after the user-defined time period. Visual (e.g. “blinking” or “flashing” etc.) or audio (e.g. tone, multi-tone or other sounds) alert signals inform the user that the login panel has been re-displayed and requires user attention. The user is able to define the type of alert signal preferred by the user. This enablement allows the user to set a distinctive and recognizable sound for the alert signal to distinguish the alert signal from other sounds which may be generated by other running programs. The “time interval” approach does not require the user's immediate response and the login panel will be periodically displayed on top of the user screen until the user responds and provides the requested information. It is noted that although a logon function is used in the present example, the invention also applies to any input panel which requires user input before a program may be continued.

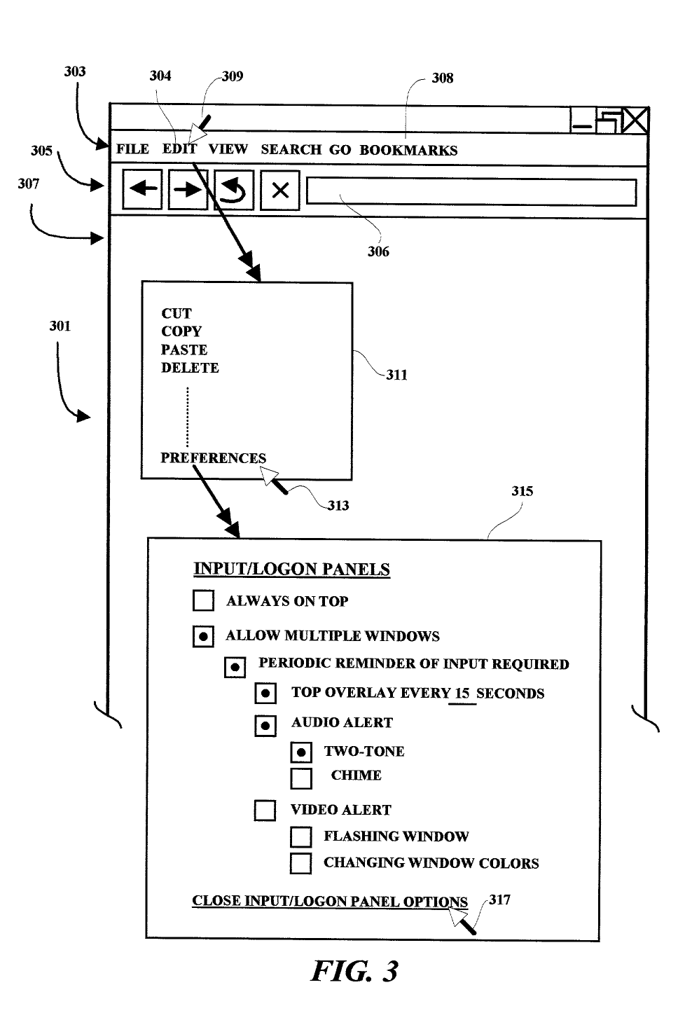

FIG. 3 illustrates a typical browser program screen display 301. The browser screen generally includes a first menubar 303 which displays several different modes which the user may select such as the “EDIT” selection 304 and the “BOOKMARKS” selection 308. Another menubar 305 may be displayed to help a user quickly move through documents, sites, or pages in a network application. An address or “location” section 306 enables a user to key-in, and also displays the name of, an internet address of a site to be, or being, visited. Other quick access buttons may be implemented on the screen for quick access to other selected network services and/or network functions. In general, any of the illustrated items may be selected through a “point and click” methodology associated with the mouse device 215, and a cursor or pointer indicium 313 visible on the display screen. For example, a download of data from a remote site may be immediately terminated during the transmission by pointing to a stop button “X” and clicking on a designated mouse button. Similarly, the “Back” and “Forward” arrow buttons may be used to return to the last screen display or go forward to the next screen display, respectively.

As shown in FIG. 3, a user is enabled to define the user's choice of alert signals which will be used in alerting the user to the presence of a logon or other input screen. Among other options, as hereinafter described, the user may select to have the alert signal presented with or without the overlay of the associated logon screen. In setting the preferences of the user, the user initially moves the pointer 309 and clicks on the EDIT function 304 in the present example. The user alert signal preference sequence may also be programmed to be initiated from other icons but the EDIT function is used in the present example. At that time a secondary screen 311 will appear and one of the choices presented to the user is the “PREFERENCES” choice. When the user points to 313 and clicks on the PREFERENCES text, an INPUT/LOGON PANELS window 315 is presented. This window allows the user to select a mode for handling logon or input panels or windows, and also to select the type and duration of the alert signals associated with the presence of the logon panel or window. As shown, by pointing to and clicking within the appropriate boxes, the user may select to have the logon panel always presented on top of other windows or to allow multiple window functioning. In the example the user has selected multiple window functioning by clicking within the corresponding square. Several additional selections are available in the multiple window mode. As shown in the example, the user has selected a top overlay of the logon window to appear every 15 seconds. The user may define any time interval desired by the user. The user has also selected an audio two-tone alert to distinguish this alert signal from other sounds which may be generated by other programs running on the computer. Other types of sounds may also be listed for selection such as chimes, sirens, etc. A user may also select a type of video alert such as a flashing window or sequencing colors of the logon window. Any one of the audio and video signals may selected by itself or in combination with any other type of video or audio type. The preferences listed are only partial lists and many more types of alerts may be included on the preference menu 315. After making appropriate selections, the user enters the selections by pointing 317 and clicking on the CLOSE hypertext. At that time, the selected logon panel alert signal processing will be applied to any logon or other entry panels which are presented on the user's display.

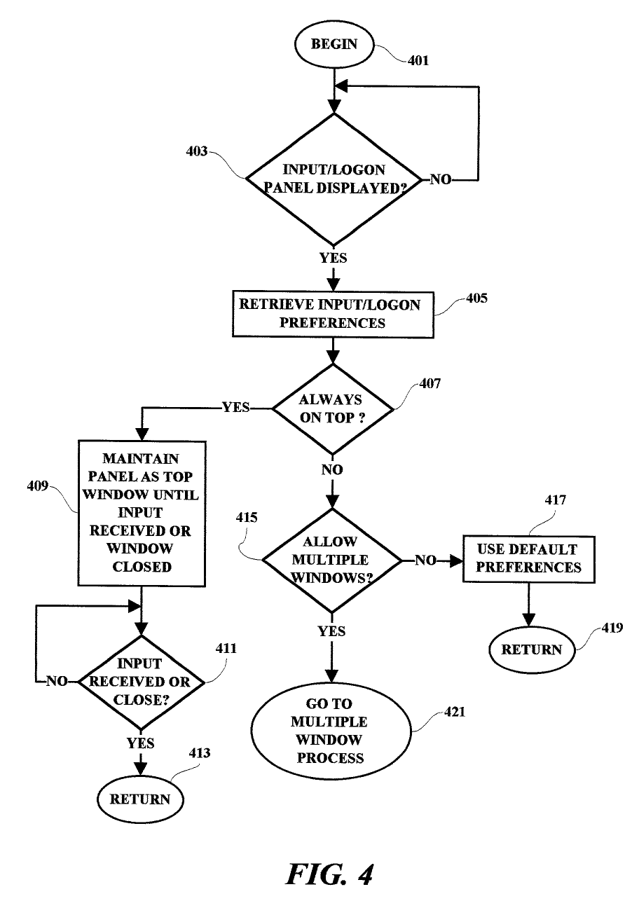

After entering the user preferences as illustrated in FIG. 3, the user-preferred logon panel processing sequence is set. As shown in FIG. 4, the logon processing begins 401 and when the presentation of a logon panel is detected 403, the user preferences are retrieved 405. If the preferences indicate that the logon panel should always be on top 407, then the program maintains the logon panel as the top window 409 until input is received from the user or the logon window is closed by the user 411 at which time the process returns to the browser program. If the user preferences indicate that multiple windows are not allowed 415 then the processing will continue using default preferences 417 and return 419 to the browser program flow.

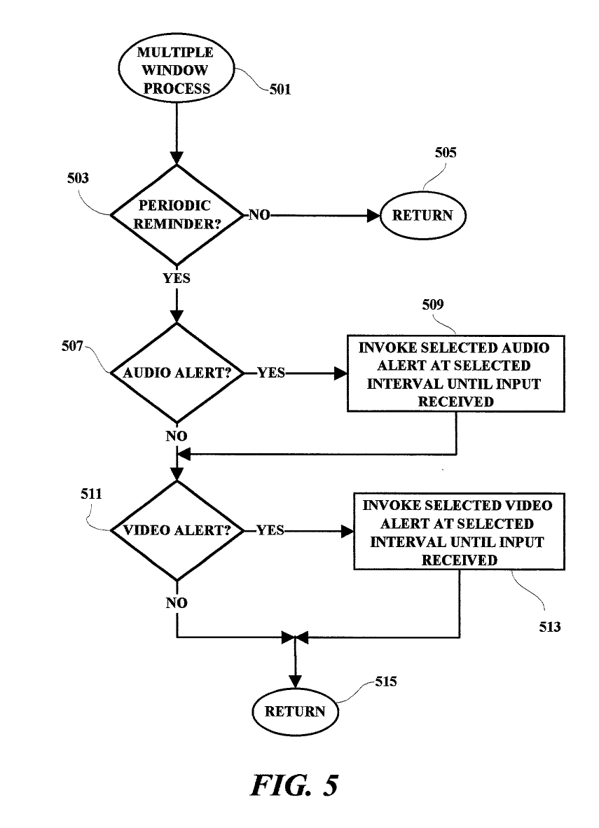

As shown in FIG. 5, if multiple window functioning is allowed 501 as indicated in the user preferences 315 (FIG. 3), then the process checks to determine if a periodic reminder preference has been selected 503. If not, then the processing returns to the browser program flow. If the user had checked the periodic reminder preference 503, then checks are made to determine 507 and implement 509 the type of audio alert selected, and also to determine 511 and implement 513 the type of video alert selected. All of the selected alerts are executed at the interval selected by the user as determined from the preference menu screen 315, until the required user input to the logon panel has been received. After implementing the selected audio and video alerts, the process will be returned to the browser program.

Although the present invention has been described herein in connection with a user terminal comprising a personal computer, it is understood that the disclosed methodology may also be implemented in other user terminal devices including portable, wireless and mobile devices which include input and display means. Further, although the method and apparatus of the present invention has been described in connection with a preferred embodiment as disclosed herein, it is understood that the disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented partially or totally in program code stored on a disk or diskette (portable or fixed), or other memory device, from which it may be executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing a display of an entry panel window on a display device of a user terminal, said entry panel window being selectively caused to appear on said display device to enable input of information in order to effect a continuation of an application coupled to said user terminal, said method comprising:
enabling a user to specify entry panel window parameters, said entry panel window parameters being selectively applicable for defining predetermined characteristics associated with a display of said entry panel window;
detecting a receipt of a request to present an entry panel window on said display device; and
displaying said entry panel window in accordance with said entry panel window parameters.

2. The method as set forth in claim 1 wherein said entry panel window parameters include a specification that said entry panel window is always displayed on top of other windows appearing on said display device.

3. The method as set forth in claim 1 wherein said entry panel window parameters include a specification that said entry panel window intermittently appears on top of other windows appearing on said display device.

4. The method as set forth in claim 3 wherein said entry panel window parameters include a specification that said entry panel window is caused to appear on top of other windows appearing on said display device at regular intervals.

5. The method as set forth in claim 1 wherein said entry panel window parameters include a specification of a perceptible alert signal, said method further including generating said perceptible alert signal in response to said detecting.

6. The method as set forth in claim 5 wherein said perceptible alert signal is an audio alert signal designed to alert said user to a detection of said entry panel window.

7. The method as set forth in claim 6 and further including enabling a user to select said audio alert signal from a number of different audio alert signals.

8. The method as set forth in claim 5 wherein said perceptible alert signal is a video alert signal designed to alert said user to a detection of said entry panel window.

9. The method as set forth in claim 8 and further including enabling a user to select said video alert signal from a number of different video alert signals.

10. The method as set forth in claim 5 and further including enabling a user to select a combination of audio and video alert signals wherein said combination of alert signals is designed to alert said user to a detection of said entry panel window.

11. A user terminal including input means and a display device, said user terminal being selectively operable to effect a display of an entry panel window to enable input of information through said input means in order to effect a continuation of an application coupled to said user terminal, said user terminal further including:
means for enabling a user to specify entry panel window parameters, said entry panel window parameters being selectively applicable for defining predetermined characteristics associated with a display of said entry panel window;
means for detecting a receipt of a request to present an entry panel window on said display device; and
means for displaying said entry panel window on said display device in accordance with said entry panel window parameters.

12. The user terminal as set forth in claim 11 wherein said entry panel window parameters include a specification that said entry panel window is always displayed on top of other windows appearing on said display device.

13. The user terminal as set forth in claim 11 wherein said entry panel window parameters include a specification that said entry panel window intermittently appears on top of other windows appearing on said display device.

14. The user terminal as set forth in claim 13 wherein said entry panel window parameters include a specification that said entry panel window is caused to appear on top of other windows appearing on said display device at regular intervals.

15. The user terminal as set forth in claim 11 wherein said entry panel window parameters include a specification of a perceptible alert signal, said user terminal further including means for generating said perceptible alert signal in response to said detecting.

16. The user terminal as set forth in claim 15 wherein said perceptible alert signal is an audio alert signal designed to alert said user to a detection of said entry panel window.

17. The user terminal as set forth in claim 16 and further including means for enabling a user to select said audio alert signal from a number of different audio alert signals.

18. The user terminal as set forth in claim 15 wherein said perceptible alert signal is a video alert signal designed to alert said user to a detection of said entry panel window.

19. The user terminal as set forth in claim 18 and further including means for enabling a user to select said video alert signal from a number of different video alert signals.

20. The user terminal as set forth in claim 15 and further including means for enabling a user to select a combination of audio and video alert signals wherein said combination of alert signals is designed to alert said user to a detection of said entry panel window.

21. The user terminal as set forth in claim 11 wherein said user terminal is a wireless device.

22. The user terminal as set forth in claim 11 wherein said user terminal comprises a personal computer.

23. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable for processing a display of an entry panel window on a display device of a user terminal, said entry panel window being selectively caused to appear on said display device to enable input of information in order to effect a continuation of an application coupled to said user terminal, said program signals being further selectively operable for:
enabling a user to specify entry panel window parameters, said entry panel window parameters being selectively applicable for defining predetermined characteristics associated with a display of said entry panel window;
detecting a receipt of a request to present an entry panel window on said display device; and
displaying said entry panel window in accordance with said entry panel window parameters.
